(19) United States
(12) Patent Application Publication
(10) Pub. No.: US 2007/0211755 A1
(43) Pub. Date: Sep. 13, 2007

(54) Communications network and method of increasing bandwidth in a cable network

(75) Inventors: Schah Walli Ali, Boca Raton, FL (US); Thomas Nagel, Boca Raton, FL (US)

Correspondence Address: Siemens Corporation;Intellectual Property Department, 170 Wood Avenue South, Iselin, NJ, 08830, US

(73) Assignee: Siemens Aktiengesellschaft

(21) Appl. No.: 11/715,531

(22) Filed: Mar. 8, 2007

Related U.S. Application Data
(60) Provisional application No. 60/781,032, filed on Mar. 10, 2006.

(51) Int. Cl. H04J 3/22

(52) U.S. Cl. 370/465

(57) ABSTRACT

In one aspect, an optical component is migrated into a cable network to increase bandwidth of a subscriber to the cable network. The subscriber uses a customer premises equipment to communicate with the cable network via a coaxial cable. The migration is such that the subscriber may keep their customer premises.

### CROSS-REFERENCE TO RELATED APPLICATIONS

The present application claims the benefit of the provisional patent application filed on Mar. 10, 2006, and assigned application No. 60/781,032.

### FIELD OF THE INVENTION

The present invention relates to increasing bandwidth in a network, and more particularly, to increasing the bandwidth in a cable network by migrating an optical component.

### BACKGROUND

Network providers are often faced with the desire to increase the bandwidth in their network. The term “bandwidth” is used to describe the width of the range of frequencies that a signal uses on a transmission medium as well as to describe a transfer rate of data on the transmission medium. In the use of bandwidth to describe the range width of a signal, the bandwidth is expressed in hertz (the number of cycles of change per second) and calculated as the difference in hertz between the highest frequency for the signal and the lowest signal for the signal. In the use of bandwidth to describe a transfer rate, the bandwidth is expressed in bits per second (bps). An increase in the width of the range of frequencies increases the transfer rate. Likewise, a decrease in the width of the range of frequencies decreases the transfer rate.

### SUMMARY OF THE INVENTION

An aspect of the present invention involves a method of migrating a passive optical network component into a communication network. The method comprises providing a plurality of subscriber each having a customer premises equipment that communicates with a cable network over a coaxial cable. The cable network includes a cable modem termination system, which is connected to a head-end device. The head-end device is connected to an edge device. A communication between the cable modem termination system and the subscriber uses electrical signals and a communication between the cable modem termination system and the edge device uses optical signals. The method further comprises providing an upstream traffic from the plurality of subscribers that passes through the cable modem termination system, providing a downstream traffic to the plurality of subscriber that passes through the cable modem termination system, and migrating an optical network terminal into the communication network for use by a portion of the plurality of subscribers such that a bandwidth of an upstream traffic from the portion of subscribers is increased and such that the upstream traffic of the portion of subscribers bypasses the cable modem termination system.

Another aspect of the present invention involves a method of migrating a passive optical network component into a communication network. The method comprises providing a plurality of subscriber each having a customer premises equipment that communicates with a cable network over a coaxial cable, providing an upstream traffic from the plurality of subscribers that passes through a cable modem termination system, providing a downstream traffic to the plurality of subscriber that passes through the cable modem termination system, and migrating an optical network terminal into the communication network for use by a portion of the plurality of subscribers such that a bandwidth of a downstream traffic from the portion of subscribers is increased and such that the downstream traffic of the portion of subscribers bypasses the cable modem termination system.

Yet another aspect of the present invention involves a communication network. The network includes a plurality of subscribers, an upstream traffic, a downstream traffic, an optical network terminal, and a bandwidth of an upstream traffic from a portion of subscribers. The plurality of subscribers each has a cable modem that communicates with a cable network over a coaxial cable. The upstream traffic from the plurality of subscribers passes through a cable modem termination system. The downstream traffic to the plurality of subscriber passes through the cable modem termination system. The optical network terminal is migrated into the communication network for use by the portion of the plurality of subscribers such that a bandwidth of an upstream traffic from the portion of subscribers is increased, such that the upstream traffic bypasses the cable modem termination system, and such that the customer premises equipment functions in the migrated network without a modification.

### BRIEF DESCRIPTION OF THE DRAWINGS

The above mentioned and other concepts of the present invention will now be described with reference to the drawings of the exemplary and preferred embodiments of the present invention. The illustrated embodiments are intended to illustrate, but not to limit the invention. The drawings contain the following figures, in which like numbers refer to like parts throughout the description and drawings wherein:

FIG. 1 illustrates a prior art schematic diagram of an exemplary hybrid fiber coax (HFC) network;

FIG. 2 illustrates a schematic diagram of an exemplary embodiment of a HFC network with a migrated optical component;

FIG. 3 illustrates a schematic diagram of another exemplary embodiment of a HFC network with a migrated optical component; and

FIG. 4 illustrates an exemplary embodiment of a table with survey criterion to base a migration of a HFC network.

### DETAILED DESCRIPTION OF THE INVENTION

The invention described herein may employ one or more of the following concepts. For example, one concept relates to migrating optical components into a network having a cable network. Another concept relates to migrating the optical components for a portion of the subscribers of the cable network. Another concept relates providing more bandwidth to a subscriber via the migration. Another concept relates to providing a higher quality of service in the network via the migration. Yet another concept relates to allowing a subscriber to keep their current customer premises equipment (CPE) without modification. Still another concept relates to determining an area for migration.

The exemplary embodiments of the invention are disclosed in context of use of a HFC network. The principles of the present invention, however, are not limited to use within an HFC network but may be applied to other cable networks wherein coaxial cable is used to connect a subscriber to the network. Also, while the exemplary embodiments describe migrating an Optical Network Terminal (ONT) into an HFC network, other optical network devices that terminate to a subscriber may be used, such as an Optical Network Unit (ONU). Thus, the illustration and description of the present invention in context of a migrating an ONT into the HFC network is merely one possible application of the present invention.

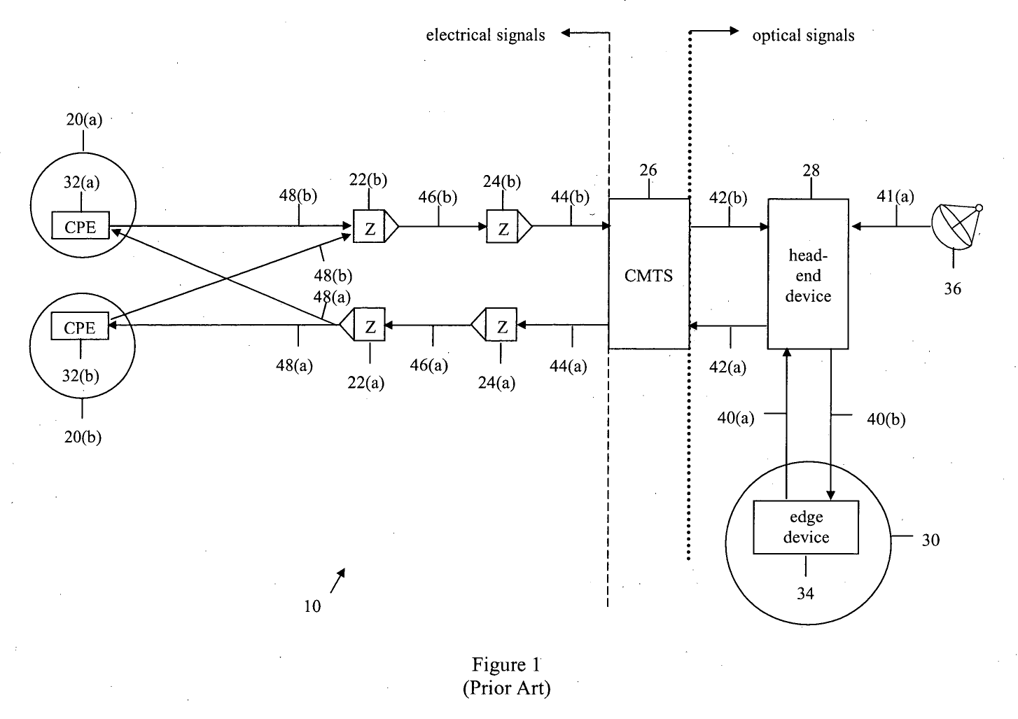

Referring to FIG. 1, a prior art schematic diagram of an exemplary HFC network 10 is illustrated. The HFC network 10 is a cable network that includes a combination of optical components and coaxial cable. The optical components provides the high-speed backbone and coaxial cable is used to connect the subscribers 20 to the backbone. The exemplary HFC network 10 includes a plurality of subscribers 20, a plurality of amplifiers 22, a plurality of filters 24(b) a Cable Modem Termination System (CMTS) 26, a head-end device 28, a satellite receiver 36, and an Internet Service Provider (ISP) 30.

The subscriber 20 includes a CPE 32, such as a cable modem, which is coupled to the network via a coaxial cable. Throughout this document, the term “coupled” refers to any direct or indirect communication between two or more elements in the network 10, whether or not those elements are in physical contact with one another.

The coaxial cable is coupled to amplifiers 22 and filters 24 to amplify and filter the traffic on the coaxial cable. The term “traffic” refers to a packet, a message, streams, or other suitable form(s) of data, voice or combinations thereof. The coaxial cable is further coupled to the CMTS 26, which is coupled to the head-end device 28. The head-end device 28 is further coupled to the ISP 30 via an edge device 34 and may be coupled to other devices such as a satellite receiver 36.

Traffic in the direction toward the subscriber is considered downstream traffic 40(a), 41(a), 42(a), 44(a), 46(a), 48(a). Traffic in the direction toward the ISP 30 is considered upstream traffic 40(b), 42(b), 44(b), 46(b), 48(b). The head-end device 28 may receive traffic 40(a) from the ISP 30 or other devices such as the satellite receiver 36. Additionally, the head-end device 28 may send traffic 40(b) to the ISP 30. Traffic 40 between the head-end device 28 and the ISP 30 is handled via optical components, thus the traffic is based on optical signals.

Additionally, traffic 42 between the head-end device 28 and the CMTS 26 is handled via optical components. The head-end device 28 multiplexes the received traffic 41(a), 40(a) using frequency-division multiplexing (FDM) into an aggregated traffic 42(a), which is then sent downstream to the CMTS 34.

The CMTS 34 converts the incoming traffic 42(a) from optical signals to an outgoing traffic 44(a) with electrical signals. The converted traffic 44(a) is fed into the hi-pass filter 24(a) to reduce low frequency noise and thereby producing traffic 46(a) having an electric signal with a frequency range of approximately 54-860 MHz.

The traffic 46(a) is fed into an amplifier 22(a). The amplified traffic 48(a) is then sent to the subscribers 20 via the respective CPE 32.

In the upstream path, the subscriber 20 sends traffic 48(b) to the network 10 via the respective CPE 32. The traffic 48(b), which has an electric signal with a frequency range of approximately 5-42 MHz is amplified via an amplifier 22(b). The amplified traffic 46(b) is fed into the low-pass filter 24(b) to reduce high frequency noise and thereby producing traffic 44(b). The traffic 44(b) is then sent to the CMTS 34 where the signal is converted from electrical signals to a traffic 42(b) having optical signals. Then the traffic 42(b) is sent to the head-end device 28 and traffic 40(b) is sent to the edge device 34.

Both the downstream bandwidth and the upstream bandwidth are shared between up to approximately 2000 subscribers. Consequently, the usable bandwidth per subscriber is limited if all the subscribers are active at the same time. Furthermore, the upstream frequency range may experience noise interference due to signals within or approximately within the upstream frequency range, such as ham radio citizen band (CB).

Network providers face many demands for bandwidth. For example, subscribers may request higher speed access. Also, new services may be added to the network, which will need to share the bandwidth. Moreover, some services require relatively large amounts of bandwidth, e.g. video services, in both the upstream and the downstream directions. Consequently, network providers are challenged in providing sufficient bandwidth in order to fulfill the requirements of the services and the demands of subscribers. In particular, cable networks such as the HFC network 10 are challenged due to the relative low bandwidth of approximately 30 Mbps in the upstream direction.

In order to provide the sufficient bandwidth, in order to fulfill the service requirements and subscriber demands, changes to the HFC network 10 are needed to increase the bandwidth. This may be achieved by converting the HFC network 10 a Passive Optical Network (PON) network. However, a complete changeover would not leverage the current cable network 26 infrastructure and would be costly to implement. Furthermore, it may be desirable to migrate only a part of the network to have certain features of the PON.

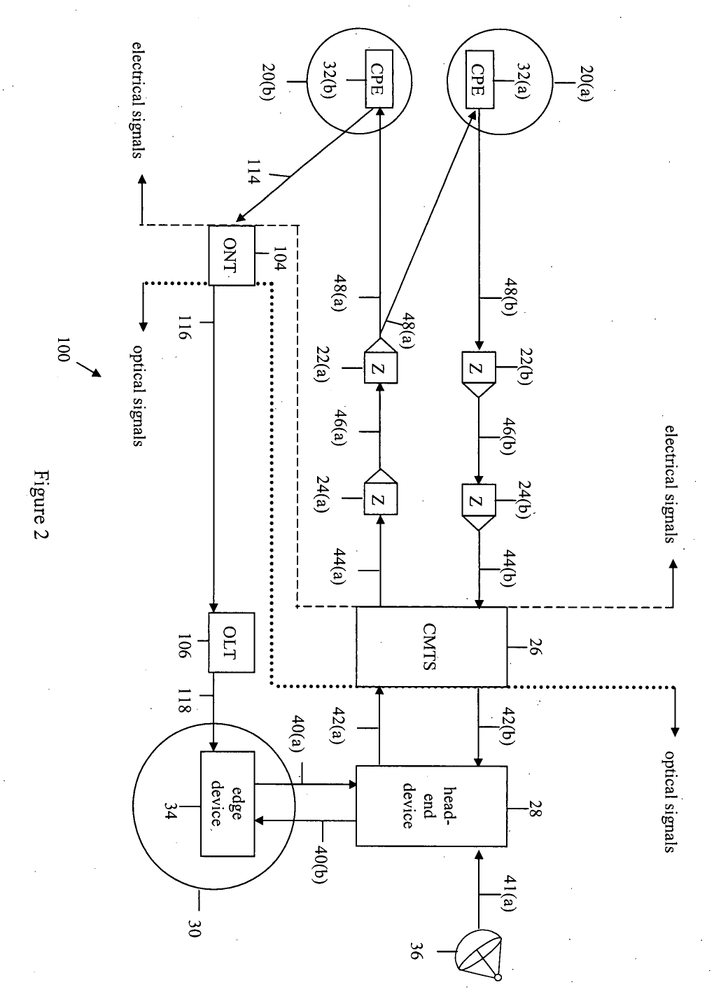

Referring now to FIG. 2, a schematic diagram of an exemplary embodiment of a HFC network 100 is illustrated. The exemplary HFC network 100 includes a plurality of subscribers 20, a head-end device 28, a satellite receiver 18, an Internet Service Provider (ISP) 30, an Optical Network Terminal (ONT), 104 and Optical Line Terminal (OLT) 106. The ONT 104 is coupled to the subscriber via a coaxial cable and optically to the OLT 106. The OLT 106 is further coupled to the edge device 34. The ONT 104 and OLT 106 have been migrated into the HFC network 100 to provide an upstream traffic for at least a portion of the subscribers 20(b) in the network 100 as described below. In the exemplary embodiment, the ONT 104 is physically closer to the subscriber 20(b) than the filter 22.

For subscriber 20(a), the downstream traffic 40(a), 41(a), 42(a), 44(a), 46(a), 48(a) and the upstream traffic 48(b), 46(b), 44(b), 42(b), 40(b) is as described for FIG. 1. For subscriber 20(b), the downstream traffic 40(a), 41(a), 42(a), 44(a), 46(a), 48(a) is also as described for FIG. 1; however, the upstream traffic 114, 116, 118 utilizes the migrated ONT 104 and OLT 106. Each ONT 104 would a serve a relatively small subset of subscribers 20(b) in comparison to the number of subscribers 20 served by the network 10 in FIG. 1. For example the ONT 104 may serve 100 or less subscribers 20(b). By serving fewer subscribers 20(b), the number of subscribers 20(b) having to share the upstream bandwidth is decreased. Thus, each subscriber 20(b) may use more upstream bandwidth. The upstream bandwidth is increased above 30 Mbps.

Additionally, by migrating the ONT 104 relatively close to the subscriber 20(b), e.g. approximately within 1 mile, the potential for noise interference in the upstream traffic 114, 116, 118 is reduced. Therefore, a desired increase in the signal to noise ratio is achieved. This reduction is due to a smaller distance in which the upstream traffic 114 travels in the coax cable. Also, if the ONT 104 is migrated to replace the last amplifier 22 prior to the subscriber 20(b), the signal to noise ration may be increased since the upstream traffic does not have to be amplified by the amplifiers 22(b) in the cable network 26.

Also, the migration allows the subscriber 20(b) to use their existing CPE 32(b). Thus the subscriber 20(b) would not need to make any changes to the hardware, software, or connections of the CPE 32. Therefore, the subscriber 20(b) may not be aware of changes to the HFC network 100 except for maybe positive aspects, such as an increased performance or a service enhancement. In contrast, if the subscriber 20(b) has to change the CPE 32 the subscriber may choose instead to use a competitor's network.

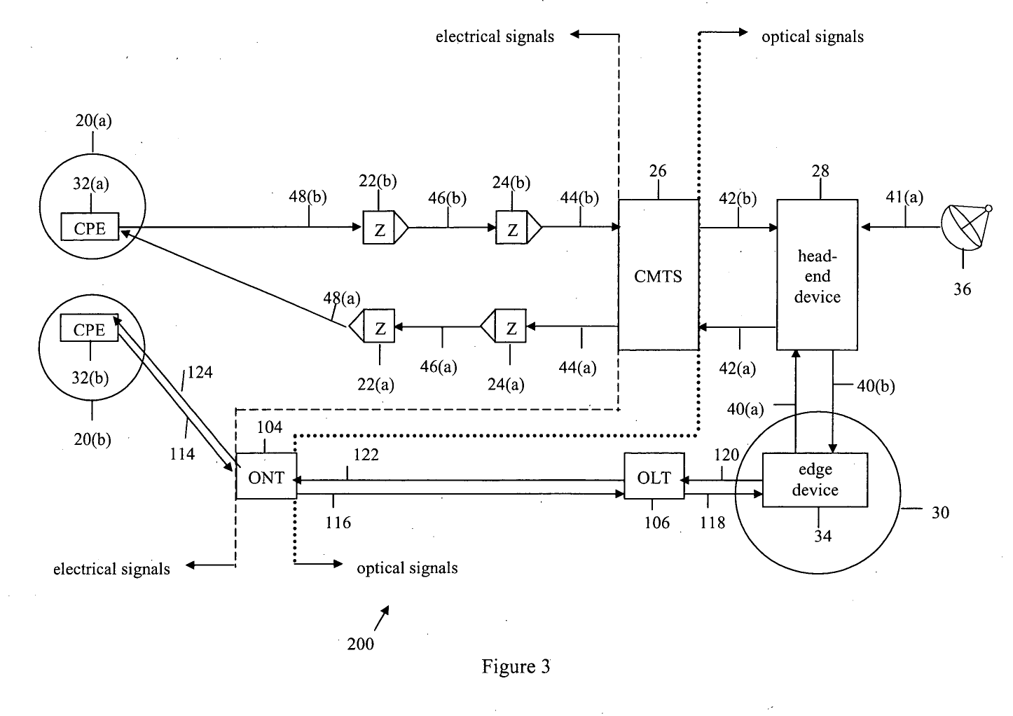

Referring now to FIGS. 2 and 3, a schematic diagram of another exemplary embodiment of a HFC network 200 is illustrated. In the exemplary embodiment illustrated by FIG. 3, the HFC network 100 has been further migrated to use the ONT 104 and OLT 106 to provide a downstream traffic 120, 122, 124 for the subscribers 20(b). Since the number of subscribers 20(b) coupled to the ONT 104 is less than the number of subscriber 20, the number of subscribers 20(b) having to share the downstream bandwidth from the ONT 104 is decreased. Thus, each subscriber 20(b) may use more downstream bandwidth.

Since the ONT 104 is relatively close to the subscriber 20(b), the potential for noise interference is for the downstream traffic is reduced.

Those skilled in the art would recognize that the migration may only include the upstream traffic or only the downstream traffic. Additionally, the migration may allow for a portion of the downstream traffic to be migrated, for example just a television signal portion. Furthermore, those skilled in the art would recognize that the migration that includes the upstream and downstream traffic may be done in a different order that is the downstream traffic migrated before the upstream traffic.

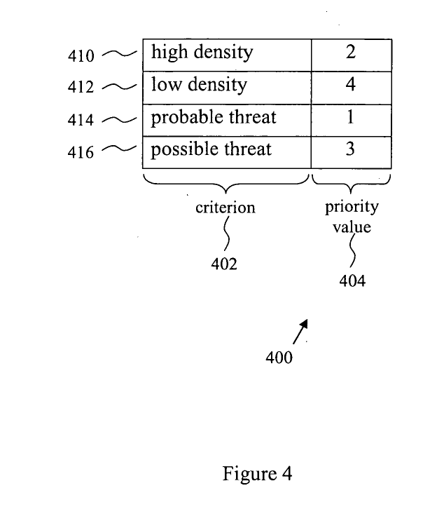

Moreover, the migration would allow a survey of the demographics of the subscribers to determine which subscribers to migrate or target for migration. Referring now to FIGS. 2 and 4 an exemplary embodiment of a table 400 with survey criterion 402 to base a migration of a HFC network is provided.

For example, a survey criterion 402 may be based on a density 410, 412 of subscribers in a highly dense area 410 of subscribers 20(a) may be migrated. By selecting an area that has a large number of subscribers 29(a) of HFC network 10, 100 20(a) a higher utilization of the ONT 104 may be realized, thus making the migration cost effective. A low dense area 412 of subscribers 20(a), such as a rural area, might not be selected for migration due to a higher cost for migration.

Another survey criterion 402 may be based on a competitor network offering. 414, 416 The term “probable threat” 414 is used to describe a competitor capable of providing greater bandwidth to the subscriber 20(a) prior to migration the subscriber 20(a) or able to provide services to the subscriber 20(a) that the HFC network 10, 100 would not be able to provide without migrating the subscriber 20(a). For example, subscribers 20(a) in areas without a competitor or a without a probable threat 414 may not be selected for migration. However, subscribers 20(a) in areas with a probable threat 414 may be selected for migration in order reduce the threat of loosing a customer base.

Another survey criterion 402 may be based on a strategy of a competitor. The term “possible threat” 416 is used to describe a plan of a competitor to providing greater bandwidth to the subscriber 20(a) prior to migration the subscriber 20(a) or a plan to provide services to the subscriber 20(a) that the HFC network 10, 100 would not be able to provide without migrating the subscriber 20(a). For example, subscribers 20(a) in areas without a competitor or a without possible threat 416 may not be selected for migration. However, subscribers 20(a) in areas with possible threat 416 may be selected for migration in order reduce the threat of loosing a customer base.

The different survey criterion 402 may also have a priority value 404. The priority value 404 could be used to determine and order to apply a criterion 402. For example a probable threat 414 may have a higher priority value than a possible threat 416 such that subscribers having a in an area of a probable threat 414 would be migrated prior to subscribers in an area of a possible threat 416.

While the invention has been described in terms of a certain preferred embodiment and suggested possible modifications thereto, other embodiments and modifications apparent to those of ordinary skill in the art are also within the scope of this invention without departure from the spirit and scope of this invention. For example, a HFC 100, 200, 300 is not limited to a single ISP 30 and may have more filters 24 and amplifiers 22. Furthermore, it would be understood by those of ordinary skill in the art that a plurality of ONT 104 and/or OLT 106 may be migrated into the network. Thus, the scope of the invention should be determined based upon the appended claims and their legal equivalents, rather than the specific embodiments described above.

1. A method of migrating a passive optical network component into a communication network, comprising:
providing a plurality of subscriber each having a customer premises equipment that communicates with a cable network over a coaxial cable;
wherein the cable network includes a cable modem termination system,
which is connected to a head-end device,
wherein the head-end device is connected to an edge device,
wherein a communication between the cable modem termination system and the subscriber uses electrical signals,
wherein a communication between the cable modem termination system and the edge device uses optical signals;
providing an upstream traffic from the plurality of subscribers that passes through the cable modem termination system;
providing a downstream traffic to the plurality of subscriber that passes through the cable modem termination system; and
integrating an optical network terminal into the communication network for use by a portion of the plurality of subscribers such that a bandwidth of an upstream traffic from the portion of subscribers is increased and such that the upstream traffic of the portion of subscribers bypasses the cable modem termination system.

2. The method as claimed in claim 1, wherein the customer premises equipment is a cable modem.

3. The method as claimed in claim 1, wherein the customer premises equipment functions in the migrated network without a modification to the customer premises equipment.

4. The method as claimed in claim 1, wherein the portion of the plurality of subscribers is 100 subscribers or less.

5. The method as claimed in claim 1, wherein the optical network component converts the electrical signal from the subscriber to an optical signal.

6. The method as claimed in claim 5, further comprises integrating an optical line terminal between the optical network terminal and the edge device.

7. The method as claimed in claim 6, wherein the upstream traffic bypasses the cable modem termination system and is directed to the edge device via the optical network terminal and the optical line terminal.

8. The method as claimed in claim 1, wherein a decision to migrate is based on a survey criterion of the portion of subscribers.

9. The method as claimed in claim 8, wherein the survey criterion is based on a population density.

10. The method as claimed in claim 8, wherein the survey criterion is based on a strategy of a competitor.

11. A method of migrating a passive optical network component into a communication network, comprising:
providing a plurality of subscriber each having a customer premises equipment that communicates with a cable network over a coaxial cable;
providing an upstream traffic from the plurality of subscribers that passes through a cable modem termination system;
providing a downstream traffic to the plurality of subscriber that passes through the cable modem termination system; and
integrating an optical network terminal into the communication network for use by a portion of the plurality of subscribers such that a bandwidth of a downstream traffic from the portion of subscribers is increased and such that the downstream traffic of the portion of subscribers bypasses the cable modem termination system.

12. The method as claimed in claim 11, wherein the customer premises equipment functions in the migrated network without modification to the customer premises equipment.

13. The method as claimed in claim 12, wherein the downstream traffic bypasses the cable modem termination system and is directed to the edge device via the optical network terminal and the optical line terminal.

14. The method as claimed in claim 13, wherein a decision to migrate is based on a survey criterion of the portion of subscribers.

15. The method as claimed in claim 14, wherein the survey criterion is based on a population density.

16. The method as claimed in claim 14, wherein the survey criterion is based on a strategy of a competitor.

17. A communication network, comprising:
a plurality of subscribers each having a cable modem that communicates with a cable network over a coaxial cable;
an upstream traffic from the plurality of subscribers that passes through a cable modem termination system;
a downstream traffic to the plurality of subscriber that passes through the cable modem termination system; and
an optical network terminal migrated into the communication network for use by a portion of the plurality of subscribers such that
a bandwidth of an upstream traffic from the portion of subscribers is increased
the upstream traffic bypasses the cable modem termination system, and
the customer premises equipment functions in the migrated network without a modification.

18. The network as claimed in claim 17, wherein a decision to migrate is based on a survey criterion of the portion of subscribers.

19. The network as claimed in claim 18, wherein the survey criterion is based on a population density.

20. The network as claimed in claim 18, wherein the survey criterion is based on a strategy of a competitor.
